(19) United States
(12) Patent Application Publication
(10) Pub. No.: US 2005/0184223 A1
(43) Pub. Date: Aug. 25, 2005

(54) Object detecting apparatus

(76) Inventor: Makoto Inomata, Handa-city (JP)

Correspondence Address: HARNESS, DICKEY & PIERCE, P.L.C., P.O. BOX 828, BLOOMFIELD HILLS, MI, 48303, US

(21) Appl. No.: 11/043,915

(22) Filed: Jan. 26, 2005

(30) Foreign Application Priority Data
Feb. 19, 2004 (JP) 2004-043181

(51) Int. Cl. H01J 40/14; G01C 3/08; G01V 8/00

(52) U.S. Cl. 250/221; 356/4.01; 250/559.38

(57) ABSTRACT

An object detecting apparatus comprises a light radiation unit and a light receiver unit disposed in a case. The case has a light radiating window and a light receiving window for transmission of laser light therethrough from the radiation unit and to the receiver unit, respectively. A step-shaped window frame is formed in the case for each window. An adhesive is pasted along the window frame and a window plate is attached to the frame, so that the window plate is fixed to the case air-tightly by the adhesive.

### CROSS REFERENCE TO RELATED APPLICATION

This application is based on and incorporates herein by reference Japanese Patent Application No. 2004-43181 filed on Feb. 19, 2004.

### FIELD OF THE INVENTION

The present invention relates to an object detecting apparatus mounted on a vehicle, for instance, for detecting an object such as a preceding vehicle or a distance to such an object by using an electromagnetic wave such as a light wave.

### BACKGROUND OF THE INVENTION

A conventional object detecting apparatus mounted on a vehicle uses a laser light, for instance, to detect an object or a distance to such an object like a preceding vehicle. This detecting apparatus intermittently drives a laser diode to radiate the laser light towards the forward area of the vehicle, and detects the light reflected from the forward obstacle by a photo sensor. The detecting apparatus measures the distance to the forward obstacle based on a time difference between a light radiation time and a light receiving time.

Specifically, as disclosed in JP 2002-031685A, the detecting apparatus comprises a light radiation unit for radiating a laser light, a polygon mirror and a light receiver unit for receiving a reflected light. The polygon mirror is shaped in a frustum of a hexagonal pyramid and rotatable as a scanning mirror. According to this construction, the polygon mirror reflects the laser light radiated from the light radiation unit and directs it to the forward area of the vehicle. As the polygon mirror is rotated and the laser light from the light radiation unit is directed to each side surface of the polygon mirror, so that the angle of reflection of the laser light at the polygon mirror is adjusted to scan a predetermined range of the forward area of the vehicle by the laser light. The receiver unit includes a Fresnel lens and a light receiving element to receive the laser light reflected from the forward object and measure the distance to the object.

Various component parts of the apparatus including the above parts are accommodated within a closed case so that a scanning mechanism, optical devices and electronic circuits are protected from frosting of water or foreign matters such as dust.

For passing the laser light through the case, the case is formed to have a light radiating window for radiating the laser light outward to the object and a light receiving window for receiving the laser light reflected by the object. Those windows are made of light-transmitting material, and fit in respective opening provided in the case. An O-ring is disposed between each window and the case in the compressed state to provide air-tightness between the inside and outside of the case.

To maintain the appropriate compression state of the O-ring for the air-tight sealing function, the dimension, sealing surface roughness or the like of the O-ring must be accurately controlled. Further, the O-ring must be accurately assembled to the case.

### SUMMARY OF THE INVENTION

It is therefore an object of the present invention to provide an object detecting apparatus, which simplifies a sealing structure of wave transmitting windows.

According to the present invention, an object detecting apparatus comprises a wave radiation unit and a wave receiver unit disposed in a case. The case has a wave radiating window and a wave receiving window for transmission of electromagnetic wave therethrough from the radiation unit and to the receiver unit, respectively. A window frame is formed in the case for each window. An adhesive is pasted along the window frame and a window plate is attached to the frame, so that the window plate is fixed to the case air-tightly by the adhesive. Preferably, the window frame is step-shaped and the window plate is attached from the outside of the case.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view of an object detecting apparatus according to an embodiment of the present invention;

FIG. 2 is a sectional view of the apparatus shown in FIG. 1; and

FIG. 3 is a sectional view of a sealing structure of a window in the apparatus taken along a line III-III in FIG. 1.

### DETAILED DESCRIPTION OF THE PREFERRED EMBODIMENT

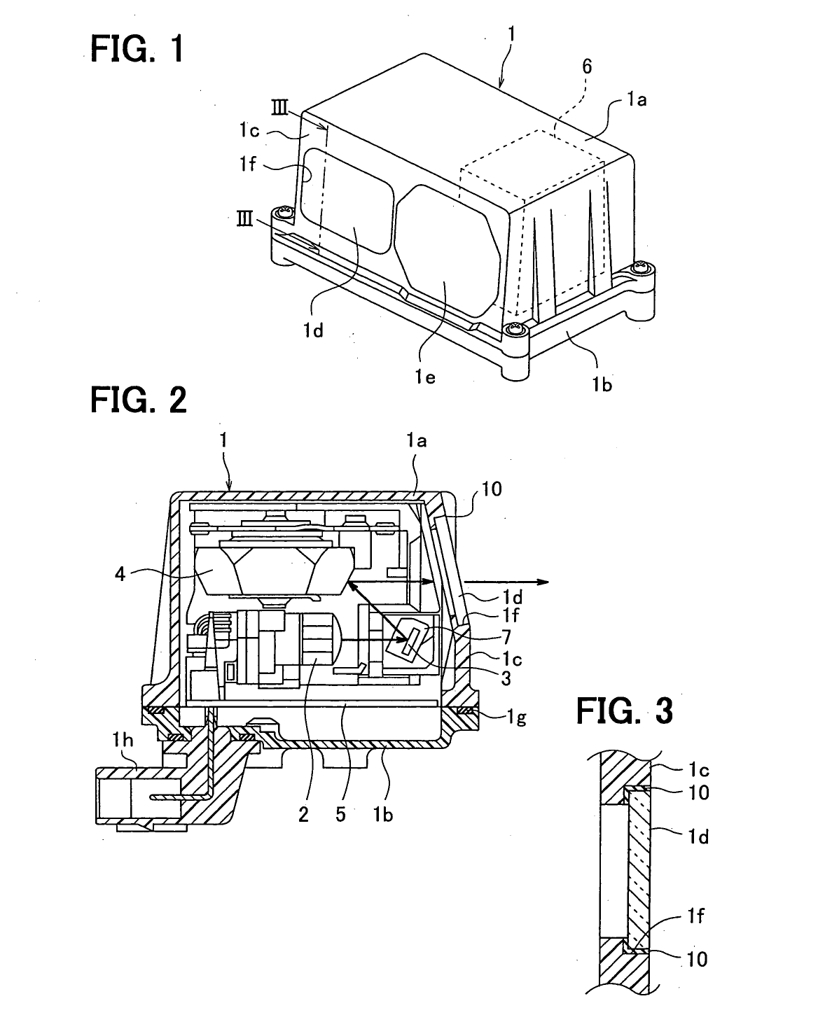

Referring first to FIGS. 1 and 2, an object detecting apparatus includes a case 1 shaped in a cuboid and various component parts accommodated in the case 1. The apparatus is mounted on a vehicle to be used as a laser radar. The apparatus is positioned to radiate a laser light in the forward direction of the vehicle (rightward direction in FIG. 2) to detect a distance to a forward object such as a preceding vehicle during an auto-cruise control condition.

The case 1 includes a first case 1a and a second case 1b. The first case 1a is box-shaped and open at its one side (bottom side in FIG. 2). The first case 1a accommodates therein various component parts. The first case 1a has a resin wall part 1c made of black PPS resin and form a housing. The first case 1a has a light radiating window 1d and a light receiving window 1e arranged at the left and the right sections on the front-side resin part 1d. The windows 1d and 1e include light-transmitting plate such as glass and acrylic resin.

As shown in FIG. 3, the resin wall part 1c is formed a window frame 1f in the form of a step to receive therein a window plate of the radiating window 1d. The width and length of the window frame 1f in the resin part 1c is made a little longer than the width and length of window plate. Similarly the depth of the window frame 1f is made a little deeper larger than the thickness of the window plate.

An adhesive 10 is pasted in a uniform thickness along the window frame 1f and the plate 1d is fit in the window frame 1f from the outside of the case 1. Thus, a small gap between the window frame 1f and the window plate 1d is air-tightly sealed by the adhesive 10. The adhesive may be a material such as epoxy resin that can secure air-tightness between the outside and the inside of the radiating window 1d.

For instance, the width and the length of the plate of the radiating window 1d is about several tens of millimeters and the thickness of the same is about 5 mm. The width and length of the window frame 1f is about 0.2 to 0.6 mm larger than those of the window plate. The depth of the window frame 1f is about 0.1 mm larger than that of the window plate. Thus, the outside surfaces of the resin part 1c and the window plate are made substantially flush with each other. The light receiving window 1e is provided in the case 1 in the same manner as the light radiating window 1d.

The second case 1b is made of a die-cast aluminum and attached to the bottom part of the first case 1a. Specifically, a sealing member 1g such as a rubber is disposed between the first case 1a and the second case 1b along the opening of the first case 1a. The first case 1a and the second case 1b are tightly threaded to each other, thereby providing air-tightness by the sealing member 1g in the compressed state.

The second case 1b has an electrical connector 1h made of resin. The connector 1h partly projects from the second case 1b to connect the electrical parts (not shown) provided inside and outside the case 1.

The case 1 (1a and 1b) accommodates a light radiation unit 2, a reflection mirror 3, a polygon mirror 4 and an electric circuit board 5. The circuit board 5 includes an electronic control circuit, which are connected to the light radiation unit 2, a light receiving unit 6 and the like to measure the distance to the forward object. The light receiving unit 6 is positioned inside the case 1 to face the light receiving window 1e and includes a Fresnel lens and a light receiving element.

The light radiation unit 2 is driven by the control circuit provided on the circuit board 5 and radiates the laser light towards the reflection mirror 3. The light radiation unit 2 may include a laser diode to radiate the laser light in the pulse form.

The reflection mirror 3 reflects the laser light radiated from the radiation unit 3 and directs it to the polygon mirror 4. The reflection mirror 3 is supported swingably to the inner case 1c by a support part 7 fixed to the inside wall of the case 1. For instance, the reflection mirror 3 may be driven by a motor (not shown) and controlled by the electric circuit of the circuit board 5 to adjust the direction of reflection.

The polygon mirror 4 is shaped in a frustum hexagonal prism and supported by the case 1. The mirror 4 is rotatable about an axis of the hexagonal prism. This mirror 4 is also driven by a motor (not shown) controlled by the control circuit of the circuit board 5. The polygon mirror 4 has around its periphery mirror faces, each of which operates as a scanning reflection mirror.

Specifically, the polygon mirror 4 reflects the laser light radiated from the radiation unit 2 and reflected by the reflection mirror 3, and directs the laser light toward the vehicle forward area through the radiating window 1d. As the polygon mirror 4 is rotated, the angle of the side face of the polygon mirror 4 changes. As a result, the angle of projection of the laser light is changed to scan a predetermined forward area of the vehicle.

The light receiver unit 6 includes the Fresnel lens and the light receiving element such as a photo diode. The Fresnel lens collects the laser light reflected from the forward object and received through the window 1e. The light receiving element receives the collected light and produces an output voltage or output current varying with the intensity of the received light. The output voltage or current is applied to the control circuit of the circuit board 5.

The object detecting apparatus constructed as above operates in the following manner, assuming that it is mounted in a vehicle and an auto-cruise control system switch is turned on. The following operation is mostly controlled by the control circuit of the circuit board 5.

The reflection mirror 3 is first driven to a predetermined angular position by the motor. The light radiation unit 2 radiates the laser light at predetermined intervals. The laser light is reflected by the reflection mirror 3 and the polygon mirror 4 to be directed toward the forward area of the vehicle through the radiating window 1d as shown with an arrow in FIG. 2. When the laser light is reflected by an object such as a preceding vehicle, the reflected light passes the light enters the light receiver unit 6 through the light receiving window 1e.

In the light receiver unit 6, the reflected light is collected by the Fresnel lens and received by the light receiving element. The light receiving element generates an output signal in response to the reception of the collected light. Based on this output signal, the control circuit calculates a distance L to the forward object by using the laser light travel speed V and the time difference T between the laser light radiation by the radiation unit 2 and the reception of the laser light by the light receiver unit 6: L=V×T/2.

The calculated distance is output through the connector 1h to various devices such as an engine control ECU and a brake control ECU provided outside the case 1. As a result, the ECUs may control an engine and/or brakes to maintain the distance to the object at a predetermined distance.

According to the above embodiment, each plate of the windows 1d and 1e is air-tightly attached to the first case 1a by the adhesive 10 pasted in the window frame 1f. Thus, various drawbacks caused in using O-rings are obviated.

The above embodiment may be modified in various ways. For instance, the size of the windows 1d and 1e and window frame 1f as well as the material for the adhesive 10 may be changed as the case may be. Further, other electromagnetic waves such as a milliwave may be used in place of the laser light wave. The object detecting apparatus may be used in various situations other than vehicles.

1. An object detecting apparatus for detecting an object, the apparatus comprising:
a wave radiation unit for radiating an electromagnetic wave;
a wave receiver unit for receiving the electromagnetic wave reflected by the object;
a case accommodating the wave radiation unit and the wave receiver unit and having wave radiating window and a wave receiving window for transmission of the electromagnetic waves from the wave radiation unit and the wave receiver unit, respectively, the case further having a window frame formed in a wall part of the case for each of the wave radiating window and the wave receiving window;
a window plate provided in the window frame; and
an adhesive pasted on the window frame to fix the plate to the wall part of the case.

2. The object detecting apparatus as in claim 1, wherein the adhesive is pasted in a uniform thickness along an entire length of the window frame.

3. The object detecting apparatus as in claim 1, wherein the window frame is shaped in a step form and sized to keep outside surfaces of the wall part of the case and the window plate flush.
